(19) United States
(12) Patent Application Publication
(10) Pub. No.: US 2004/0197570 A1
(43) Pub. Date: Oct. 7, 2004

(54) Prepolymers of allophanate-modified MDI and polyoxypropylene polyol

(76) Inventors: William E. Slack, Moundsville, WV (US); Edward P. Squiller, Bridgeville, PA (US); P. Richard Hergenrother, Gibsonia, PA (US)

Correspondence Address: BAYER MATERIAL SCIENCE LLC, 100 BAYER ROAD, PITTSBURGH, PA, 15205, US

(21) Appl. No.: 10/405,148

(22) Filed: Apr. 2, 2003

(51) Int. Cl. C08G 18/00

(52) U.S. Cl. 428/423.1; 528/60; 528/59

(57) ABSTRACT

The present invention provides an NCO prepolymer as described herein. The NCO prepolymer of the present invention finds use in preparing elastomeric coatings, adhesives, sealants and the like.

### FIELD OF THE INVENTION

The present invention relates in general to polyurethane, and more specifically, to a diphenylmethane diisocyanate (MDI) prepolymer containing an allophanate-modified MDI with a polyoxypropylene polyol. The MDI prepolymer of the present invention is particularly useful in making elastomeric coatings, adhesives, sealants and the like.

### BACKGROUND OF THE INVENTION

European Patent No. EP 0,573,206 B1 issued to Barksby discloses polyurethane prepolymers made by reacting a polyether polyol mixture with a polyisocyanate. The polyol mixture of Barksby includes, a) a polyether diol, and b) a polyether polyol having 3 or more hydroxyl groups.

U.S. Pat. No. 5,663,272 issued to Slack et al, discloses allophanate-modified MDI which is produced by reacting a monoisocyanate and an organic compound having at least two hydroxyl groups and a molecular weight of from about 60 to about 6,000 to form a urethane. The urethane is reacted with an isomeric mixture of MDI in an amount such that the product isocyanate has an NCO content of from about 12 to about 30%. The isomeric mixture of MDI is composed of 4,4′-diphenylmethane diisocyanate containing from 0 to about 60% by weight 2,4′-MDI and less than 6% by weight of the 2,2′-MDI. The allophanate-modified MDI of Slack is reacted with an organic isocyanate-reactive material to produce an allophanate-modified MDI prepolymer containing urethane, urea and/or biuret groups and having an NCO content which is generally from about 5 to about 29% by weight. Slack et al. is silent as to the use of an all polyoxypropylene polyol in allophanate-modified MDI prepolymers.

U.S. Pat. No. 5,677,413, issued to Barksby et al., discloses polyurethane elastomers prepared from ultra-low unsaturation polyoxypropylene polyols containing up to 20 weight percent internal random oxyethylene moieties. The internal polyoxyethylene moiety-containing polyoxypropylene polyols of Barksby are used to prepare ultra-low unsaturation polyoxyethylene capped polyols, which are haze-free, and may be used to prepare haze-free 4,4′-MDI prepolymers.

U.S. Pat. No. 5,821,316 issued to Quay et al., discloses polyurethane prepolymers made from toluene diisocyanate (TDI) and a blend of two polyols, a) a polyether polyol of 350-2000 equivalent weight and, b) a low molecular weight polyol of 62 to <300 molecular weight, in an equivalent ratio of low molecular weight polyol to polyether polyol of 0.25-2.7:1. The prepolymers are used to produce elastomers which are said by Quay to have good dynamic properties.

### SUMMARY OF THE INVENTION

The present invention reduces or eliminates problems inherent in the art by providing a diphenylmethane diisocyanate (MDI) prepolymer containing an allophanate-modified MDI with a polyoxypropylene polyol.

The elastomeric coatings, adhesives and the like produced using the MDI- or allophanate-modified MDI-prepolymers of the present invention (with all PO based polyether polyols) possess better hardness and tear strength than similar elastomeric coatings, adhesives and the like based on MDI or allophanate-modified MDI and PO/EO based polyether polyols.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.”

The prepolymers of the present invention contain the reaction product of

(A) an allophanate-modified diphenylmethane diisocyanate prepolymer containing the reaction product of,

(1) an allophanate-modified diphenylmethane diisocyanate having an NCO group content of 12 to 32.5% by weight and containing the reaction product of

(a) an aliphatic alcohol or an aromatic alcohol, and

(b) diphenylmethane diisocyanate containing,

(i) up to 60% by weight of 2,4′-diphenylmethane diisocyanate,

(ii) less than 6% by weight of 2,2′-diphenylmethane diisocyanate, and

(iii) the balance being 4,4′-diphenylmethane diisocyanate,

wherein the sum of the percentages by weight of (1)(b)(I), (1)(b)(ii) and (1)(b)(iii) total 100% by weight of (1)(b);

and

(2) an all PO polyether polyol having a molecular weight of 134 to 10,000, an OH number of 420 to 14 and a functionality of at least 1.8,

and/or

(B) a diphenylmethane diisocyanate prepolymer containing the reaction product of

(1) diphenylmethane diisocyanate containing,

(i) from 0 to 60% by weight of 2,4′-diphenylmethane diisocyanate,

(ii) less than 6% by weight of 2,2′-diphenylmethane diisocyanate, and

(iii) the balance being 4,4′-diphenylmethane diisocyanate,

wherein the sum of the percentages by weight of (1)(b)(I), (1)(b)(ii) and (1)(b)(iii) total 100% by weight of (1)(b);

and

(2) an all PO polyether polyol having a molecular weight of 134 to 10,000, an OH number of 420 to 14 and a functionality of at least 1.8.

Also provided are coating compositions (and coated substrates) containing the NCO prepolymer of the present invention combined with an isocyanate reactive component comprising,

(1) from 30-80% by weight based on 100% by weight of components (A) and (B) of a hydroxyl-terminated polyether polyol having a molecular weight of 400 to 4000 and having a functionality of 2, and

(2) from 70-20% by weight based on 100% by weight of components (A) and (B) of a hydroxyl-terminated polyether polyol having a molecular weight of 400 to 6000 and having a functionality of 3,

at an isocyanate index of 70 to 130, preferably 80 to 110 and more preferably at 90 to 105. The reaction of components (A), (B) and the isocyanate reactive component may optionally occur in the presence of a catalyst (D) and a desiccant (E).

Allophanates and preparation methods thereof are known in the art and are described in numerous patents including U.S. Pat. No. 3,769,318, U.S. Pat. No. 4,160,086, U.S. Pat. No. 4,177,342, U.S. Pat. No. 5,319,053 and U.S. Pat. No. 5,663,272. Allophanate-modified diphenylmethane diisocyanates are also available commercially.

Polyols useful in preparing the NCO prepolymers of the present invention are polyoxypropylene polyols, preferably diols, having a number average molecular weight of 500 to 20,000, preferably 1,000 to 15,000, and more preferably 2,000 to 12,000. Polyoxypropylene diols are known and can be produced by the propoxylation of suitable starter molecules. Methods of making such polyols are disclosed, for example, in U.S. Pat. No. U.S. Pat. No. 3,278,457, U.S. Pat. No. 4,355,188, U.S. Pat. No. 5,470,813, U.S. Pat. No. 5,432,808 and U.S. Pat. No. 5,545,610. Examples of suitable starter molecules include diols such as ethylene glycol, propylene glycol, 1,3-butanediol, 1,4-butanediol, 1,6-hexanediol, 2-ethylhexanediol-1,3; and primary monoamines such as aliphatic amines, e.g. ethylamine or butylamine. Also suitable are polypropylene glycols.

Aliphatic alcohols suitable in the present invention include, but are not limited to, isomeric butanols, isomeric propanols, isomeric pentanols, isomeric hexanols, cyclohexanol, 2-methoxyethanol, 2-bromoethanol, etc. “Aromatic” alcohols suitable in the present invention include, but are not limited to phenol, 1-naphthanol, m-cresol and p-bromophenol. The aliphatic alcohols are particularly preferred.

Catalysts capable of catalyzing the reaction between the isocyanate component (A) or (B) and isocyanate-reactive component (C) include metal carboxylates, metal halides, ammonium carboxylates, and mixtures thereof. Of the metal halides, the metal chlorides are preferred. These catalysts may be used alone or in conjunction with a tin-sulfur catalyst and/or a tertiary amine catalyst.

Examples of suitable metal carboxylates are tin carboxylates such as dimethyltin dilaurate and bismuth carboxylates such as bismuth tri-neodecanoate. Suitable metal halides include tin halides, especially tin chlorides such as dimethyltin dichloride. Examples of suitable ammonium carboxylates are trimethylhydroxyethylammonium-2-ethylhexanoate (i.e. Dabco TMR). Tin carboxylates such as dimethyltin dilaurate and bismuth carboxylates such as bismuth tri-neodecanoate are preferred catalysts. Metal chlorides such as dimethyltin dichloride are also preferred catalysts.

Suitable tin-sulfur catalysts include dialkyltin dilaurylmercaptides such as dibutyltin dilaurylmercaptide and dimethyltin dilaurylmercaptide.

Suitable tertiary amine catalysts include triethylamine, triethylenediamine, tributylamine, N-methylmorpholine, N-ethylmorpholine, triethanolamine, triisopropanol-amine, N-methyidiethanolamine, N-ethyldiethanolamine, and N,N-dimethylethanolamine.

Suitable desiccants are known in the art.

The MDI prepolymer of the present invention may preferably be used in the preparation of elastomeric coatings, adhesives, sealants and the like. Depending upon the particular application, compositions containing the MDI prepolymer of the present invention may also contain additives commonly used in the art including, but not limited to, levelling agents, wetting agents, flow control agents, antiskinning agents, antifoaming agents, fillers (such as silica, aluminium silicates and high-boiling waxes), viscosity regulators, plasticizers, pigments, dyes, UV absorbers. Stabilizers against thermal and oxidative degradation may also be included as needed.

Elastomeric coatings, adhesives, sealants and the like containing the MDI prepolymer of the present invention may preferably be applied to any heat-resistant substrate including, but not limited to, metal, glass and ceramic. The application may preferably be by methods known in the art including, but not limited to, spray-coating, spread-coating, flood-coating, dip-coating, roll-coating and casting. The coatings, adhesives, sealants and the like containing the MDI prepolymer of the present invention may be clear or pigmented.

The invention is further illustrated but is not intended to be limited by the following examples in which all parts and percentages are by weight unless otherwise specified.

### EXAMPLES

The following components were used to make the MDI-, and allophanate-modified MDI-prepolymers of the present invention.

Polyol A: Acclaim 4200, a propylene oxide polyether polyol, commercially available from Bayer Polymers LLC, having an OH number of about 28 and a functionality of about 1.98.

Polyol B: Acclaim 4220, a propylene oxide/ethylene oxide polyether polyol, (80 wt. % PO/20 wt. % EO end block), commercially available from Bayer Polymers LLC, having an OH number of about 28 and a functionality of about 1.97.

Polyol C: Mutranol 9111, a propylene oxide/ethylene oxide polyether polyol, (80 wt. % PO/20 wt. % EO end block), commercially available from Bayer Polymers LLC, having an OH number of about 28 and a functionality of about 1.82.

Polyol D: Desmophen 550U, a propylene oxide polyether polyol, commercially available from Bayer Polymers LLC, having an OH number of about 383 and a functionality of about 2.9.

Polyol E: Mutranol 3600, a propylene oxide polyether polyol, commercially available from Bayer Polymers LLC, having an OH number of about 56 and a functionality of about 1.98.

MDI-x: Diphenylmethane diisocyanate which contains less than 1% by weight 2,2′- diphenylmethane diisocyanate and in which x represents the percent by weight 2,4′- diphenylmethane diisocyanate and 100-x represents the percent by weight 4,4′- and 2,2′-diphenylmethane diisocyanate.

Catalyst A: zinc acetylacetonate.

Prepolymers

The following NCO prepolymers were made as described in detail herein below.

Prepolymer A

To 59.1 parts of MDI-2 at 60° C. was added 40.9 parts of Polyol A. The mixture was heated to 60-65° C. for two hours followed by cooling to 25° C. The final product had an NCO content of 19.0.

Prepolymer B

The procedure of Prepolymer A was followed, except Polyol A was replaced by Polyol B. The final product had an NCO content of 18.9%.

Prepolymer C

To 66.8 parts of MDI-2 at 50° C. was added 2.1 parts isobutanol. The mixture was heated to 90° C. Catalyst A (75 ppm) was added and the reaction mixture held at 90° C. for one and a half hours. Benzoyl chloride (150 ppm) was added. The allophanate-modified MDI had an NCO content of 29.0% by weight. This allophanate-modified MDI was cooled to 60° C. and 31.1 parts of Polyol A was added. The reaction mixture was held at 60-65° C. for two hours and then cooled to 25° C. The resulting prepolymer had an NCO content of 19.1% and a viscosity at 25° C. of 384 mPa s.

Prepolymer D

To 66.8 parts of MDI-2 at 50° C was added 2.1 parts isobutanol. The mixture was heated to 90° C. Catalyst A (75 ppm) was added and the reaction mixture held at 90° C. for one and a half hours. Benzoyl chloride (150 ppm) was added. The allophanate-modified MDI had an NCO content of 29.0% by weight. This allophanate-modified MDI was cooled to 60° C. and 31.1 parts of Polyol B was added. The reaction mixture was held at 60-65° C. for two hours and then cooled to 25° C. The resulting prepolymer had an NCO content of 19.1% and a viscosity at 25° C. of 430 mPa s.

Prepolymer E

To 61 parts of MDI-2 at 50° C. was added 3.3 parts isobutanol. The mixture was heated to 90° C. Catalyst A (75 ppm) was added and the reaction mixture held at 90° C. for one and a half hours. Benzoyl chloride (150 ppm) was added. The allophanate-modified MDI had an NCO content of 26.0% by weight. This allophanate-modified MDI was cooled to 60° C. and 35.7 parts of Polyol A was added. The reaction mixture was held at 60-65° C. for two hours and then cooled to 25° C. The resulting prepolymer had an NCO content of 16.0% and a viscosity at 25° C. of 1244 mPa s.

Prepolymer F

The procedure of Prepolymer E was repeated, except Polyol A was replaced by Polyol B. The resulting prepolymer had an NCO content of 15.9% and a viscosity at 25° C. of 1120 mPa s.

Prepolymer G

The procedure of Prepolymer E was repeated, except Polyol A was replaced by Polyol C. The resulting prepolymer had an NCO content of 16.1% and a viscosity at 25° C. of 990 mPa s.

Elastomeric coatings, adhesives, sealants and the like may be prepared from isocyanate prepolymers of the present invention using, for example, a polyol component blend that includes the following:

750 parts by weight of Polyol D;

500 parts by weight of Polyol E; and

126 parts by weight of a desiccant made from 3Å molecular sieves and castor oil (Baylith L paste).

Samples of the prepolymers of the present invention were prepared for testing at 25° C. in the following manner:

The stated amount (as shown in Table I) of the polyol component blend described above was weighed into a 500 mL plastic cup. The appropriate amount of the prepolymer (A-G) was weighed into the plastic cup that contained the polyol component blend. The prepolymer and polyol component blend were mixed by hand-stirring with a wooded spatula for approximately 20 seconds. The resulting mixture was drawn down on glass plates using a 10 mil thick draw-down bar. Samples of the compositions were cured at 60° C. for 16 hours, followed by storage at 25° C. at 50% relative humidity for two weeks.

TABLE I

| Prepolymer | Polyol Blend | Catalyst XC6212 |
|---|---|---|
| A (232 g) | 244 g | 4.7 g |
| B (233 g) | 244 g | 4.7 g |
| C (231 g) | 244 g | 4.7 g |
| D (244 g) | 244 g | 4.7 g |
| E (274 g) | 244 g | 5.2 g |
| F (277 g) | 244 g | 5.2 g |
| G (274 g) | 244 g | 5.2 g |

Mechanical Properties

Tensile and tear strength, percent elongation and Shore Hardness A/D, of the samples cured at 60° C. were tested and the results summarized in Table II. Tensile strength and percent elongation were determined according to ASTM D-412 C. Tensile strength is reported in pounds per square inch (psi). Tear strength was determined according to ASTM D-624. Tear strength is reported in pounds per linear inch (pli). Shore Hardness A/D was determined according to ASTM D-2240.

TABLE II
Comparison of urethane prepolymers made from
all PO polyether polyols and PO/EO polyether polyols

| | Prepolymer | | | | | | |
|---|---|---|---|---|---|---|---|
| Mechanical Property | A | B | C | D | E | F | G |
| Shore Hardness A/D | 90/34 | 63/16 | 96/48 | 87/36 | 90/37 | 84/27 | 87/33 |
| Tear Strength (pli) | 87.6 | 34.2 | 155 | 120 | 145 | 103 | 113 |
| Tensile Strength (psi) | 2310 | 467 | 2837 | 2872 | 2807 | 2531 | 1827 |
| Percent Elongation | 139 | 125 | 134 | 150 | 152 | 156 | 145 |
| Polyol Type | PO | PO/EO | PO | PO/EO | PO | PO/EO | PO/EO |
| Polyol Functionality | 1.98 | 1.97 | 1.98 | 1.97 | 1.97 | 1.98 | 1.82 |

As can be appreciated by reference to Table II, the mechanical properties of articles containing the MDI prepolymer or the allophanate-modified prepolymer of the present invention incorporating a polyoxypropylene polyol rival or exceed those of articles made from a similar MDI prepolymer containing a propylene oxide/ethylene oxide (PO/EO) polyol.

The foregoing descriptions of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A diphenylmethane diisocyanate prepolymer comprising the reaction product of
(A) an allophanate-modified diphenylmethane diisocyanate prepolymer comprising the reaction product of,
(1) an allophanate-modified diphenylmethane diisocyanate having an NCO group content of about 12 to about 32.5% by weight and comprising the reaction product of
(a) an aliphatic alcohol or an aromatic alcohol, and
(b) diphenylmethane diisocyanate comprising,
(i) up to about 60% by weight of 2,4′-diphenylmethane diisocyanate,
(ii) less than about 6% by weight of 2,2′-diphenylmethane diisocyanate, and
(iii) the balance being 4,4′-diphenylmethane diisocyanate,
wherein the sum of the percentages by weight of (1 )(b)(i), (1)(b)(ii) and (1)(b)(iii) total 100% by weight of (1)(b);
and
(2) an all PO polyether polyol having a molecular weight of about 134 to about 10,000, an OH number of about 420 to about 14 and a functionality of at least about 1.8,
and
(B) a diphenylmethane diisocyanate prepolymer comprising the reaction product of
(1) diphenyl diisocyanate comprising,
(a) up to about 60% by weight of 2,4′-diphenylmethane diisocyanate,
(b) less than about 6% by weight of 2,2′-diphenylmethane diisocyanate, and
(c) the balance being 4,4′-diphenylmethane diisocyanate, wherein the sum of the percentages by weight of (1 )(b)(i), (1)(b)(ii) and (1)(b)(iii) total 100% by weight of (1)(b); and
(2) an all PO polyether polyol having a molecular weight of about 134 to about 10,000, an OH number of about 420 to about 14 and a functionality of at least about 1.8.

2. The NCO prepolymer of claim 1, wherein the aliphatic or aromatic alcohol is selected from the group consisting of, isomeric butanols, isomeric propanols, isomeric pentanols, isomeric hexanols, cyclohexanol, 2-methoxyethanol, 2-bromoethanol, phenol, 1-naphthanol, m-cresol and p-bromophenol.

3-15. (Cancelled).
